(19) United States
(12) Patent Application Publication
(10) Pub. No.: US 2015/0103152 A1
(43) Pub. Date: Apr. 16, 2015

(54) HEAD-MOUNTED STEREOSCOPIC DISPLAY

(71) Applicant: Beijing ANTVR Technology Co., LTD., Beijing (CN)

(72) Inventor: Zheng QIN, Beijing (CN)

(21) Appl. No.: 14/509,659

(22) Filed: Oct. 8, 2014

(30) Foreign Application Priority Data
Oct. 13, 2013 (CN) 201320630596.4
Dec. 4, 2013 (CN) 201310646979.5
Apr. 10, 2014 (CN) 201420172689.1
May 27, 2014 (CN) 201420273628.4

(51) Int. Cl. H04N 13/04

(52) U.S. Cl. CPC H04N 13/044
USPC 348/53

(57) ABSTRACT

The present invention provides a head-mounted stereoscopic display comprises a head-mounted base unit, a single display unit arranged on the side facing away from the human face inside the head-mounted base unit for presenting images to human eyes, optical magnifying lens which are arranged on the side near the human face of the head-mounted base unit, and the annular headband which is connected with the head-mounted base unit and extending around user's head for fixing the head-mounted base unit, the head-mounted base unit comprises a face-mask unit and an optical base unit, the face-mask unit fits with human face tightly, and the optical base unit fixes the display unit and the optical magnifying lens, the single display unit displays two different images for the left and right eyes respectively side by side simultaneously.

### CROSS-REFERENCE TO RELATED APPLICATIONS

This non-provisional application claims priority under 35 U.S.C. §119(a) on Patent Application No. 201320630596.4 filed in P.R. China on Oct. 13, 2013, Patent Application No. 201310646979.5 filed in P.R. China on Dec. 4, 2013, Patent Application No. 201420172689.1 filed in P.R. China on Apr. 10, 2014, Patent Application No. 201420273628.4 filed in P.R. China on May 27, 2014, the entire contents of which are hereby incorporated by reference.

### TECHNICAL FIELD

The present invention relates to a head-mounted stereoscopic display for immersion visual experience in the field of virtual reality.

### BACKGROUND OF THE INVENTION

Nowadays, electronics games become more and more popular with the development of electronics technology. However, common computer displays and television displays cannot meet the needs of the video game players. Thus a new type of a head-mounted near-eye display appears in the market, so the user can see the screen through a special optical magnifier by the near-eye display mounted on the head and has an immersed sense, and thus the visual experience of the game is greatly improved.

Currently, two separate display units are normally used to show left and right eye images respectively. Such products are expensive while the resolution is low, which limits the commercialization of the products. Some other products use a single display unit which is divided into two parts respectively for the left and the right eye images. But the distance from the displays to the lens is less than 50 mm, and the focal length of the lens is very short, so the images must be firstly deformed into spherical images to be showed so as to correct the spherical aberration effect caused by the lens, which makes the common video images is not suitable to be displayed by this kind of products.

Moreover, generally the near-eye displays are completely closed to block out the visible light from outside, so as to make to users see the display screen clearly. However in this case, when the player play games, if he need to find something outside, such as the mouse, the keyboard, obstacles, etc., he has to remove the head-mounted display and then to put it on again when needed, which is very inconvenient for the user to play the game.

Therefore, a new kind of head-mounted device for game player which is inexpensive and portable is needed to solve the above problems effectively.

### SUMMARY OF THE INVENTION

The present invention provides a head-mounted stereoscopic display, comprising a head-mounted base unit; a single display unit arranged on the side facing away from human face inside the head-mounted base unit for presenting images to human eyes; an optical magnifying lens arranged on the side near human face inside the head-mounted base unit; and an annular headband connected with the head-mounted base unit and extending around user's head for fixing the head-mounted base unit; wherein the head-mounted base unit comprises a face-mask unit and an optical base unit, the face-mask unit fits with the human face tightly, and the optical base unit fixes the display unit and the optical magnifying lens, and wherein the single display unit displays two different images for human's left and right eyes respectively side by side simultaneously.

Preferably, an image height-compressing lens is further arranged on the side near the display unit inside the head-mounted base unit for compressing the height of the images as displayed, so that the images observed by eyes have a normal aspect ratio.

Preferably, the image height-compressing lens is a plane-concave cylindrical lens or double-concave cylindrical lens.

Preferably, the concave surface is arc-shape whose curvature radius is ⅓˜⅕ or ⅔˜⅓ of the height of the display unit.

Preferably, the concave surface is a parabolic surface whose curvature radius on the top in cross section is ⅓˜⅕ or ⅔˜⅓ of the height of the display unit.

Preferably, the distance between the image height-compressing lens and the display unit is ⅓˜⅕ of the height of the display unit.

Preferably, the distance between the optical magnifying lens and the display unit is above 40 mm, and the focal length of the optical magnifying lens is less than 70 mm.

Preferably, the diameter of the optical magnifying lens is more than 40 mm, and the gap between the human eyes and the optical magnifying lens is more than 20 mm to accommodate eyeglasses.

Preferably, the optical magnifying lens comprises two optical magnifying lenses which are capable of rotating a certain angle from the vertical state, so that the center distance between the two optical magnifying lens will vary within a range of 60 to 70 mm.

Preferably, the face-mask unit and the optical base unit are detachable by any of a structure of rotating snap-fit engagement, rotating magnetic engagement and top sliding-slot engagement.

Preferably, the annular headband of the head-mounted base unit goes around above ears of the user, and a bone conduction sound module is provided on the annular headband to receive audio signal from outside and vibrate to spread the audio signal.

Preferably, the face-mask unit of the head-mounted base unit concaves a predetermined depth facing away from the human face side, the concave part is surrounded by a forehead-supporting part supporting on the top of the head, a cheek-supporting part supporting on the lower of the head, a nose-supporting part supporting in the middle of the face, and the annular headband supporting the left and right side of the head, so that the head-mounted base unit is held tightly with the human face. A pair of observation windows is provided in the cheek-supporting part of the head-mounted base unit in the lower part of the head, corresponding to the positions through which the user looks downwards with his left and the right eyes, and the observation windows are covered with a slideable light-blocking cover for the user to block the light as needed.

Preferably, the concave part near the observation window further concaves from the vertical direction toward the inside of the head-mounted base unit and forms a wedge triangle “∠” shape together with the cheek-supporting part, in order to provide more observation space below for human eyes to observe through the observation window.

Preferably, a sliding slot is provided in the cheek-supporting part, when the light-blocking cover is pushed forward along the sliding slot away from the human face to the end of the slot, the light-blocking cover is opened to reveal the window, and when the light-blocking cover is pushed forward along the sliding slot towards the human face, the light-blocking cover is closed to block the window.

Preferably, one end of the light-blocking cover far away from the user is provided with a rotation shaft, while the other end is in a free state, when the free end of the light-blocking cover is pushed downwards, the light-blocking cover is rotated downwards about 180 degrees and then attached with the cheek-supporting part again, the light-blocking covers is open, and when the free end of the light-blocking cover is rotated in an opposite direction, the light-blocking covers is closed.

Preferably, the light-blocking cover is in a louver type.

Preferably, the light-blocking cover is provided with a metal or magnetic component which can be engaged with a corresponding metal or magnetic component at the bottom of the head-mounted base unit, so as to be detachable from the head-mounted base unit.

Preferably, further comprising clamping components for clamping the display unit in front of the optical magnifying lens away from the human eyes, wherein the clamping components comprise a first clamping component and a second clamping component arranged in opposite sides to fix an detachable external display unit in place of the display unit in front of the user in position where the user can see the images provided by the external display unit when wearing the head-mounted stereoscopic display.

Preferably, the clamping components are rotatable oppositely or reversely within a certain range of angles by spring hinges so as to cover and fold in the front of the optical magnifying lens of the head-mounted base unit in the initial position and to clamp resiliently and fix the external display unit in the operation position.

Preferably, the clamping components are provided with one or more slots arranged respectively on the sides facing each other to adjust the distance between the display screen and the human eyes.

### BRIEF DESCRIPTION OF DRAWINGS

Further objects, functions, and advantages of the present invention will be explained in details by embodiments of the present invention with reference to the accompanying drawings.

FIG. 1 is a schematic figure which illustrates the structure of the head-mounted stereoscopic display according to the present invention.

FIG. 2 illustrates the head-mounted stereoscopic display in use.

FIG. 3a is a schematic figure which illustrates the structure of the lenses for compressing the height of images.

FIG. 3b is a principle diagram of compressing the height of the images.

FIG. 4 is a schematic figure showing the accommodate space for eyeglasses.

FIG. 5 is a schematic figure of a rotatable lens support.

FIG. 6 is a schematic figure which illustrates the detachable structure of a face-mask unit and an optical base unit.

FIG. 7a is a schematic figure showing the two states of the rotating snap-fit engagement of a face-mask unit and an optical base unit.

FIG. 7b is a schematic figure showing the two states of the rotating magnetic engagement of a face-mask unit and an optical base unit.

FIG. 7c is a schematic figure showing the engagement of a face-mask unit and an optical base unit by inserted from the top.

FIG. 8 is a schematic figure showing an observation window for observing outside.

FIG. 9a is a schematic figure showing a sliding light-blocking cover.

FIG. 9b is a schematic figure showing a rotating light-blocking cover.

FIG. 10 is a schematic figure showing a clamping component for a separate display unit.

FIG. 11a and FIG. 11b are the front view and side view respectively showing the closed and open states of the upper and lower clamping type clamping components.

FIG. 12a and FIG. 12b are the front view and top view respectively showing the closed and open states of the left and right clamping type clamping components.

FIG. 13a and FIG. 13b are the schematic figures respectively showing the hinged folding structure and the surrounded folding structure of the clamping component.

### DETAILED DESCRIPTION OF THE INVENTION

With reference to the exemplary embodiments, the purpose and function of the present invention and method to achieve these purpose and function will be explained. However, the present invention is not limited to the disclosed exemplary embodiments, and can be implemented with different forms. The description in nature is merely to help those skilled in the art to comprehensively understand the specific details of the invention.

Hereinafter, embodiments of the present invention will be explained in details with reference to drawings. In the accompanying drawings, like reference numerals designate the same or similar parts, or the same or similar procedures.

### The Overall Structure of the Present Invention

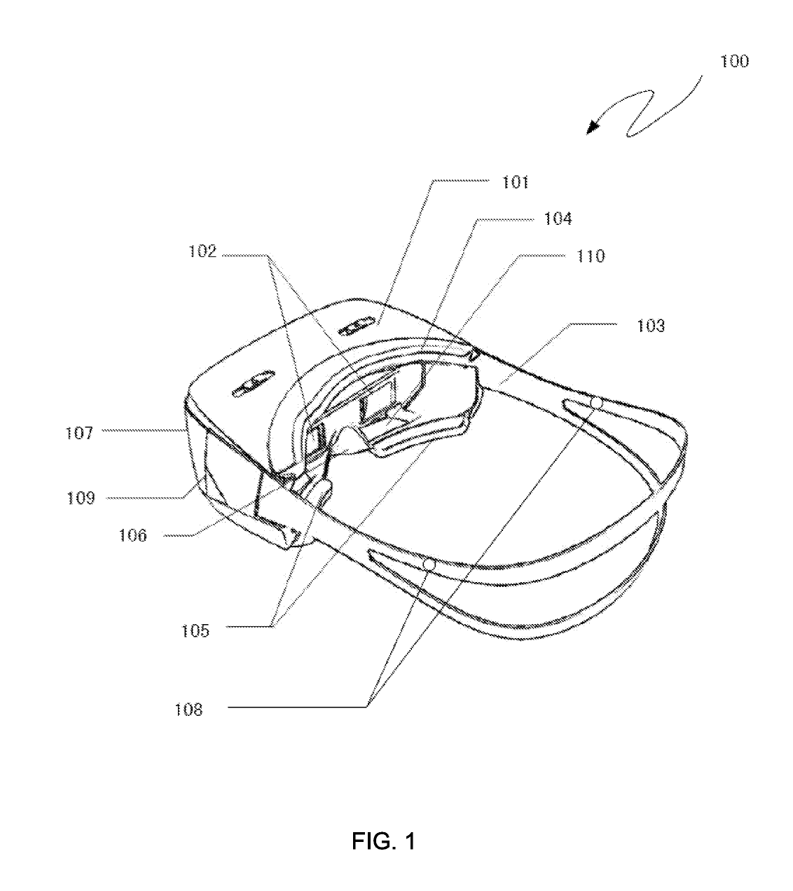

As shown in FIG. 1, the present invention provides a head-mounted stereoscopic display 100 comprising a head-mounted base unit 101, two optical magnifying lens 102 and a single display unit 107 which are arranged inside the head fixed unit 101 to provide display images for left and right eyes respectively, and an annular headband 103 which is connected with the head-mounted base unit 101 and extends around user's head for fixing the head-mounted base unit 101.

As shown in FIG. 1, the appearance of the head-mounted base unit 101 looks similar to a goggle, like a mask on the face. The inner side near the face of the head-mounted base unit 101 concaves outward (i.e. in a direction leaving away from the face) a predetermined depth. The concave part is surrounded by a forehead-supporting part 104 supported on the upper part of the head, a cheek-supporting part 105 supported on the lower part of the head, a nose-supporting part 106 supported on the middle of the face, and the annular headband 103 supported on the left and right side of the head, so as to fit the human face closely to prevent light from leaking into the head-mounted base unit 101. The depth of the concave part is designed to not only accommodate user's glasses, but also provide a predetermined space enough for human eyes to observe. As shown in FIG. 1, near an observation window 110, across the optical magnifying lens 102, the concave part further concaves from the vertical direction toward the inside of the head-mounted base unit and forms a wedge triangle “∠” shape together with the cheek-supporting part 105, in order to provide more observation space below accommodate the observation window 110 for human eyes to observe through the observation window.

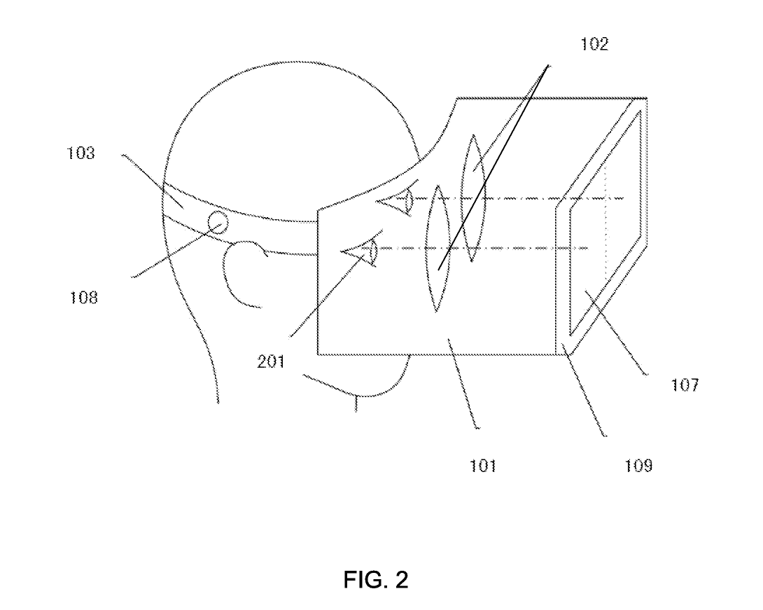

As shown in FIG. 2, the display unit 107 is fixed in front of the head-mounted base unit 101 by a display fixing unit 109. By adjusting the annular headband 103, the user can see the images provided through the optical magnifying lens clearly without being affected by the external visible light when wearing the head-mounted stereoscopic display 100. The display unit 107 can be integrated with the head-mounted stereoscopic display 100 or be a detachable external display unit which is selected from any one of flat-panel displays, mobile phone, a tablet, or other electronic devices with a display.

The display unit 107 in the present invention is a single display unit which displays two different images respectively side by side for the left and right eye of the human simultaneously.

The optical magnifying lens 102 comprises a convex lens, a spherical lens or an aspherical lens. The left and the right-eye images on the display unit 107 are refracted by optical magnifying lens 102, thus forming a magnified virtual image.

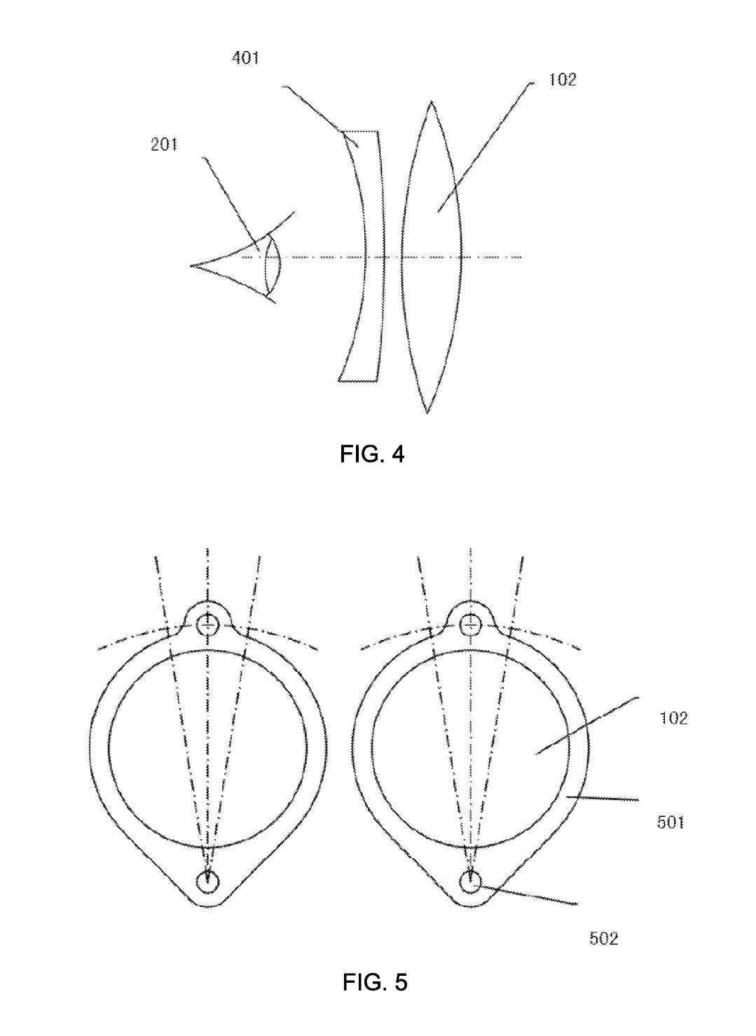

Specifically, according to an embodiment of the present invention, the distance between the optical magnifying lens 102 and the display unit 107 is over 40 mm. The focal length of the optical magnifying lens 102 is less than 70 mm. The diameter of the optical magnifying lens 102 is 40 mm. The distance from the optical magnifying lens 102 to the user's eye 201 is of 25 mm, while the eye glasses 401 has a distance of 20 mm away from the user's eye 201, so there is enough space for the user's glasses as shown in FIG. 4. It is convenient for the user using head-mounted stereoscopic display according to the present invention while wearing the glasses, so as to avoid the tedious process of eradicate refraction errors and the discomfort of eyes caused by the unreasonable eradication.

In addition, the annular headband of the head-mounted base unit goes around above ears of the user. Preferably, two bone conduction sound modules 108 are provided on the annular headband 103 and contact with the skin at the position behind the left and the right ear around the user's ears, to generate the sound for the left and right channels respectively so as to form a stereo effect.

### Image Height-Compressing Unit

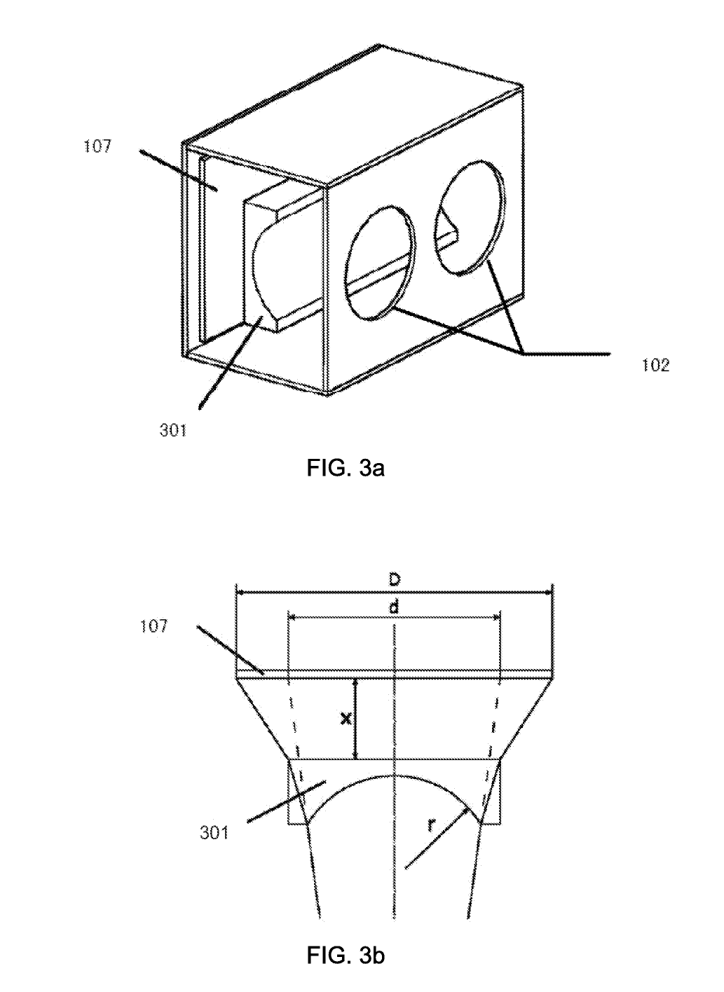

As shown in FIG. 3a, an image height-compressing lens 301 is provided near the display unit 107 inside the head-mounted base unit 101. The image height-compressing lens 301 is a plane-concave cylindrical lens or a double-concave cylindrical lens. The height of the images are compressed by the image height-compressing lens 301, i.e., in the direction perpendicular to the line connecting the two eyes of human, so that the aspect ratio of the left or right eye image is close to that of the view field of human eyes, namely 16:9 or 4:3.

FIG. 3b illustrates the principle of compressing the height of the images according to the embodiment of the present invention. In one example, the height D of the unit 107 is 80 mm. The image height-compressing lens 301 is a plane-concave cylindrical lens with a concave surface having an arc-shape surface on one side and a plane surface on the other side. The arc-shape surface has a curvature radius r of 25 mm. The distance x between the image height-compressing lens 301 and the display unit 107 is x=20 mm. By the refraction of the image height-compressing lens 301, the image height shown on the display unit 107 is compressed to d, so the deformation of the original images is corrected in this way.

Preferably, the image height-compressing lens 301 is a plane-concave cylindrical lens with an arc-shape concave surface on one side whose curvature radius in cross section is ⅓˜⅕ of the height of the display unit 107.

Preferably, the image height-compressing lens 301 is a double-concave cylindrical lens with two arc-shape concave surfaces whose curvature radius in cross section is ⅔˜⅓ of the height of the display unit 107.

Preferably, the image height-compressing lens 301 is a plane-concave lens with a parabolic concave surface on one side whose curvature radius on the top in cross section is the ⅓˜⅕ of the height of the display unit 107.

Preferably, the image height-compressing lens 301 is double-concave cylindrical lens with two parabolic concave surfaces on two sides whose curvature radius on the top in cross section is ⅔˜⅓ of the height of the display unit 107.

Preferably, the distance between the image height-compressing lens 301 and the display unit 107 is ⅓˜⅕ of the height of the display unit 107.

### Structure for Adjusting the Pupillary Distance Between the Two Lenses for Left Eye and Right Eye

FIG. 5 schematically illustrates a rotatable lens holder 501 for adjusting the optical central distance between the two lenses for left eye and right eye. According to one embodiment of the present invention, when the lens holder 501 is in a vertical state, the center distance between the two optical magnifying lenses 102 (corresponding to the pupillary distance of eyes) is in a middle-distance state, for example, 65 mm. When the lens holder 501 carries the two optical magnifying lenses 102 to rotate a certain angle from the vertical state around the rotation shaft 502 provided at the bottom of the lens holder 501 to be close to each other, the pupillary distance of the two optical magnifying lens 102 is decreased to the minimum-distance state, for example, 60 mm. When the lens holder 501 carries the two optical magnifying lens 102 to rotate a certain angle around rotation shaft 502 so that the two optical magnifying lens 102 are far away from each other, the pupillary distance between the two optical magnifying lenses 102 is increased to the maximum-distance state, for example, 70 mm.

### Detachable Structure of the Head-Mounted Base Unit 101

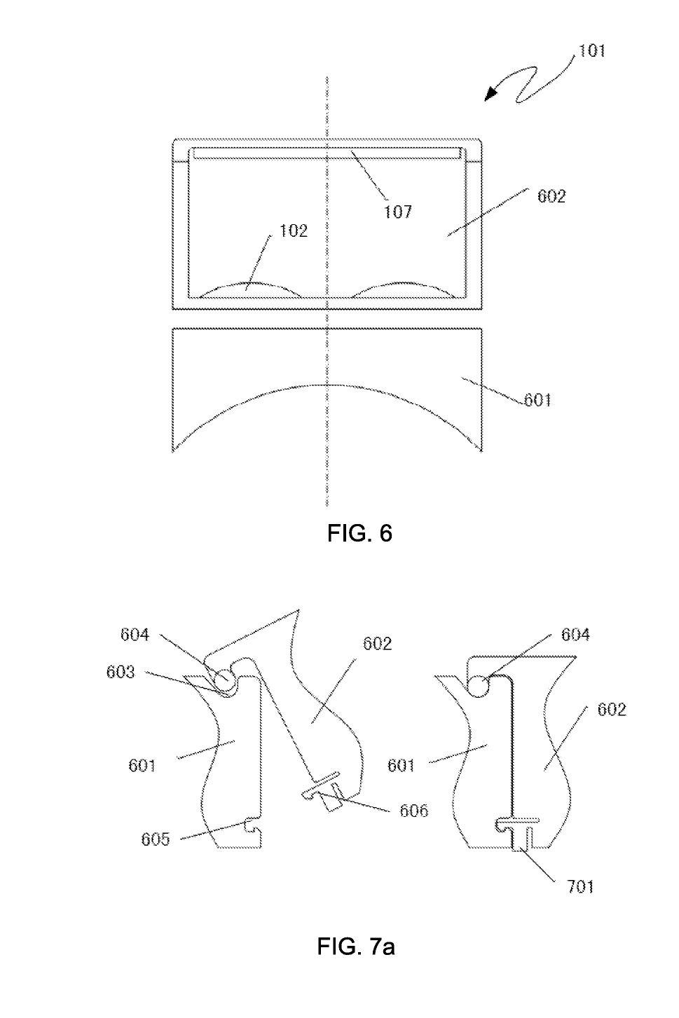

FIG. 6 schematically illustrates the detachable structure of a head-mounted base unit and an optical base unit of the head-mounted base unit 101. The head-mounted base unit 101 comprises two detachable parts, i.e., a face-mask unit 601 and an optical base unit 602. The face-mask unit 601 comprises the forehead-supporting part 104 fitted on upper part of the face, the cheek-supporting part 105 supported on lower part of the face, and the nose-supporting part 106 supported on the middle of the face. The optical base unit 602 comprising the optical magnifying lens 102, the display unit 107 and the corresponding supporting parts. With a detachable structure, the optical base unit 602 can be removed from the face-mask unit 601 while the face-mask unit 601 is still on the user's face, because there is no optical component now in the face-mask unit 601, so the user can see through the face-mask unit 601 towards outside clearly with no barriers.

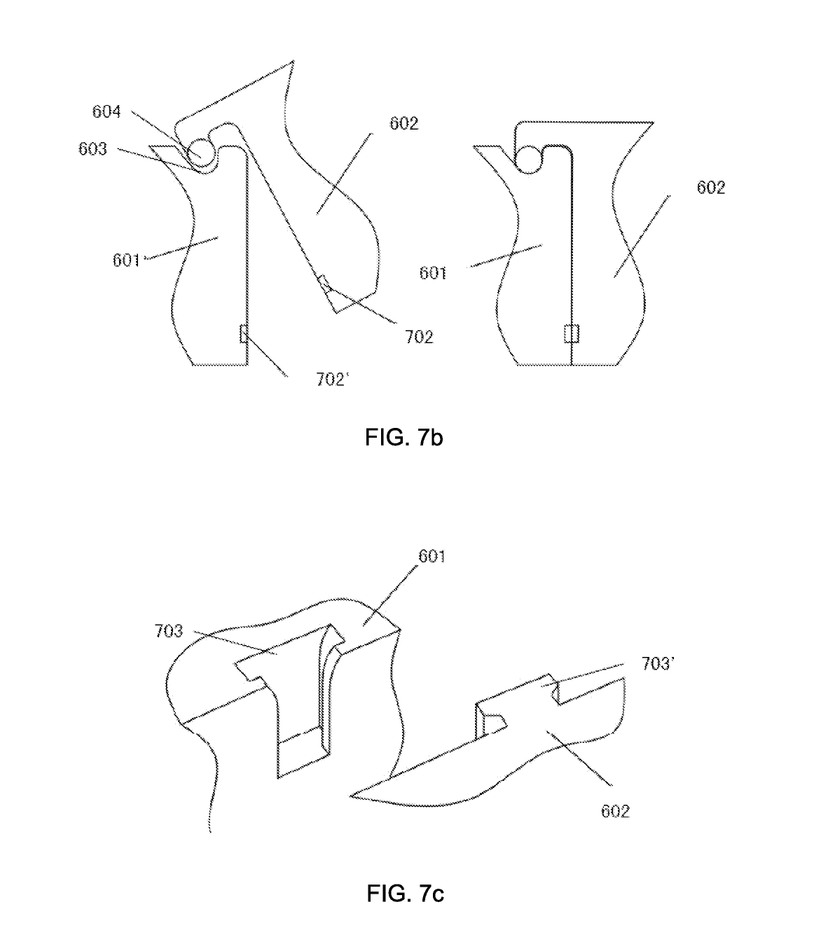

FIG. 7a-7c illustrates three embodiments showing the detachable structure of the face-mask unit 601 and the optical base unit 602.

a. In the first embodiment as shown in FIG. 7a, when the face-mask unit 601 and the optical base unit 602 are combined as a single body, the optical base unit 602 connects with the face-mask unit 601 by inserting a protruding pivot 604 in the optical base unit 602 into the corresponding notch 603 on top of the face-mask unit 601, and then the optical base unit 602 and the face-mask unit 601 are combined by rotating the optical base unit 602 downwards around the pivot 604 to insert the protruding portion 605 at the bottom of the optical base unit 602 into the corresponding engagement notch 606 of the face-mask unit 601. To detach the optical base unit 602 from the face-mask unit 601, a unlock button 701 protruding from the bottom of the optical base unit 602 is pushed up, the protruding portion 605 and the engagement notch 606 are released to disengage the combination into two parts, and then the optical base unit 602 is rotated upward around the pivot 604 to make the pivot 604 separate from the notch 603 of face-mask unit 601 from the top, and the two parts are separated.

b. In the second embodiment as shown in FIG. 7b, the face-mask unit 601 and the optical base unit 602 are provided with magnetic connectors 702 and 702′ on the opposite sides. When the face-mask unit 601 and the optical base unit 602 are combined as a single body, the optical base unit 602 connects with the face-mask unit 601 by inserting the protruding pivot 604 in the optical base unit 602 into the corresponding notch 603 on top of the face-mask unit 601, and then the optical base unit 602 and the face-mask unit 601 are combined by rotating the optical base unit 602 downwards around the pivot 604 to make the magnetic connector 702 and 702′ engage with each other tightly. To separate the face-mask unit 601 and the optical base unit 602, the optical base unit 602 is pushed outward so as to disengage the magnetic connector 702 and 702′, and then the optical base unit 602 is rotated upward around the pivot 604 to make the pivot 604 separate from the notch 603 of face-mask unit 601 from the top, and the two parts are separated.

c. In the third embodiment as shown in FIG. 7c, the face-mask unit 601 and the optical base unit 602 comprise a T-shaped notch 703 and a T-shaped protruding portion 703′ respectively which are engaged by inserting T-shaped protruding portion 703′ into the T-shaped notch 703 from the top.

### Structure of External Observation Window

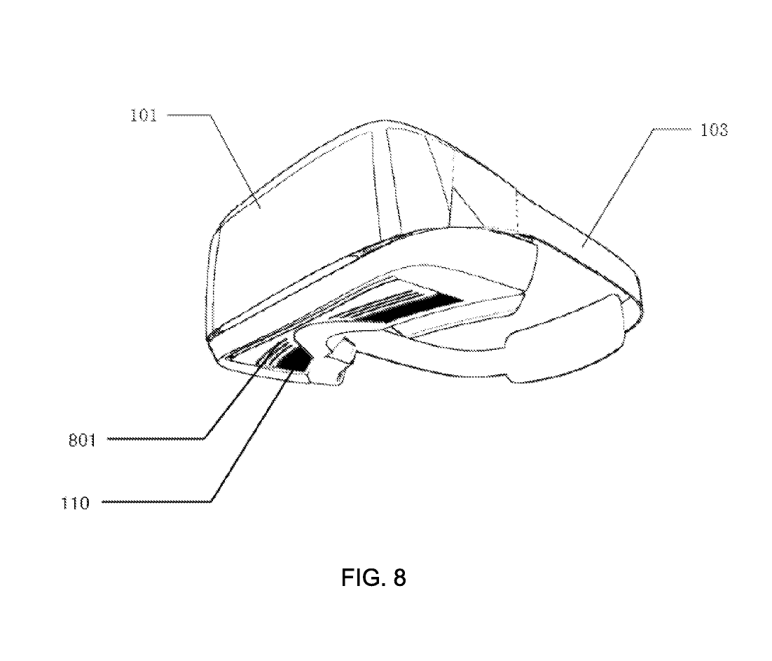

FIG. 8 illustrates an observation window 110 which is convenient for the user to look outwards when wearing the head-mounted base unit 101. A pair of observation windows 110 is provided in the cheek-supporting part 105 in the lower part of the head-mounted base unit 101, corresponding to the left and the right display units and corresponding to the places where the left and the right eye can look downwards outside. According to an embodiment of the present invention, the pair of observation windows 110 may be covered with a pair of sliding light-blocking covers 801, so that the light-blocking cover 801 covers the observation window 110 for blocking the light from the outside when the user plays game, and the light-blocking cover 801 can be removed to expose the observation window 110 when the user needs to look outside.

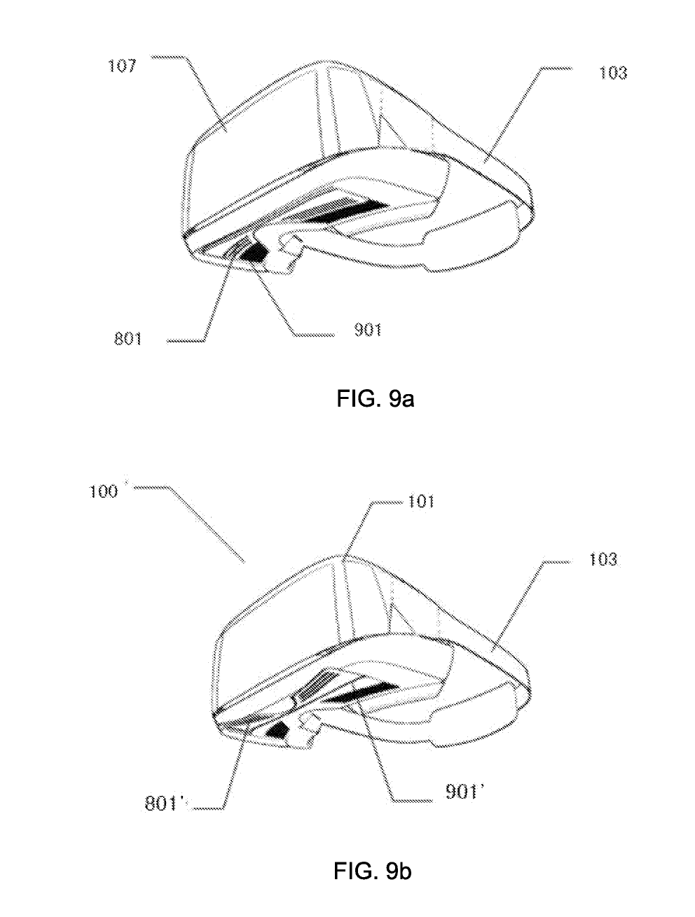

The following FIGS. 9a and 9b shows in details the structure of the light-blocking cover 801.

FIG. 9a schematically illustrates a pair of light-blocking covers 801 which is slideable. When users play game, the sliding light-blocking covers 801 completely cover the pair of the observation windows 110 in a close state. When the user need to see the mouse or keyboard or obstacles if any, he just needs to push the light-blocking covers 801 forward so as to move the covers 801 outward (away from the user) along the sliding slot 901 to the end of the sliding slots 901 to stop in a open state. The sliding slot 901 is arranged on the cheek-supporting part 105 at the bottom of the head-mounted base unit 101. In this way the observation windows 110 are exposed to allow the user see the area below and in front of the eyes through the observation windows 110.

FIG. 9b is schematically illustrates a pair of light-blocking cover 801′ which is rotatable. One end of the light-blocking cover 801′ in the front of the observation windows 110 is provided with a rotation shaft 901′, while the other end is in a free state. The rotation shaft 901′ is provided on the front end of the light-blocking cover 801′.

When users play game, the light-blocking covers 801′ completely cover the pair of observation windows 110 in a close state. When the user need to see the mouse or keyboard or obstacles if any, the user only needs to rotate the free end (near the user) of the light-blocking cover 801′ downwards by hand, so that the light-blocking cover 801′ rotates outward and downward around the rotation shaft 901′ away from the user about 180 degrees and attaches to the cheek-supporting part 105 again in an open state, so the observation windows 110 are exposed below to allow the user see the area below and in front of the eyes through the observation windows 110.

The material of the light-blocking cover 801 may be selected from any of the hard plastic, metal, rubber, soft plastic or the textile fiber product.

It can be understood by those skilled in the art that the way for opening and closing the light-blocking cover 801 above is not restrictive and can be modified according to the specific application. For example, the light-blocking cover 801 may be provided with a louver structure so that the observation windows 110 can be open or closed by finger. Alternatively, the light-blocking covers 801 may be incorporated with a pair of metal or magnetic components which are engaged with the metal or magnetic components at the bottom of the head-mounted base unit 101 so that the light-blocking covers 801 are detachably connected with the bottom of the head-mounted base unit 101.

In addition, the pair of the light-blocking covers can be integrated in one body so that they are open or closed at the same time, or they are separated so that they are opened or closed independently. The light-blocking covers may be even removed from the head-mounted stereoscopic display according to the present invention.

### Display Fixing Unit

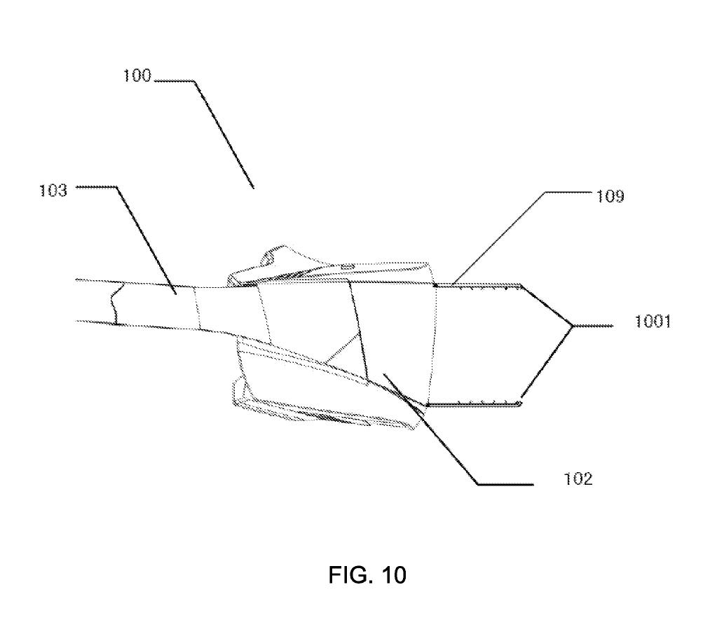

The head-mounted stereoscopic display 100 according to the present invention comprises a display fixing unit 109, which can be integrated with the head-mounted base unit 101 as a whole as shown in FIG. 1, or it can also be separate clamping components 1001 protruding from the head-mounted base unit 101 as shown in FIG. 10. The clamping components 1001 is convenient for clamping a separate external display unit in place of the single display unit 107, such as a mobile phone or other smart devices which can used as a display unit.

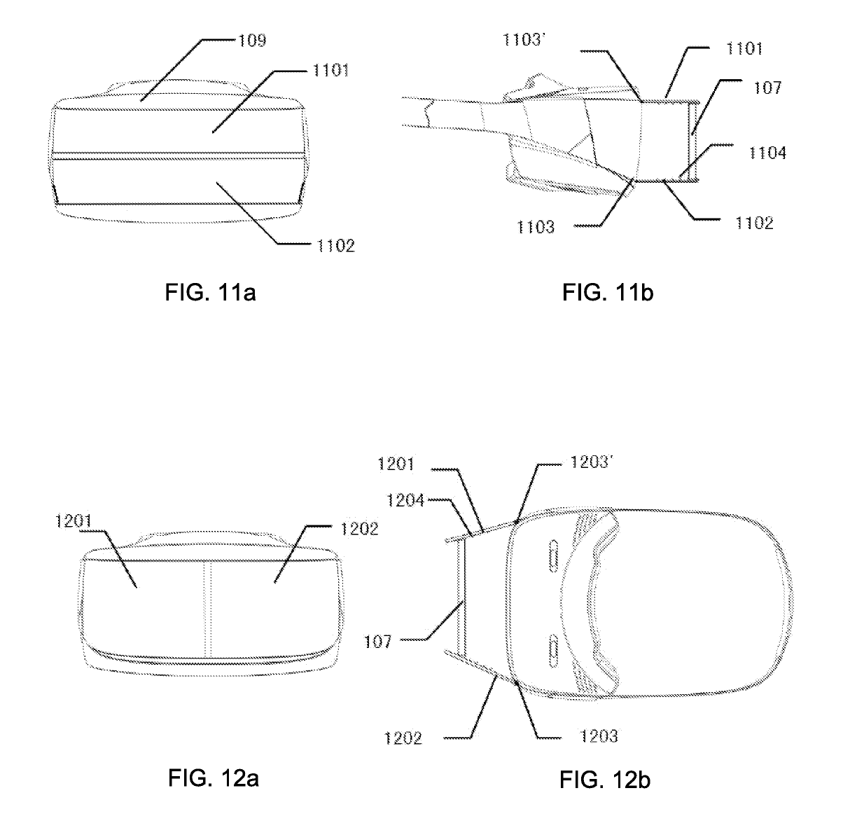

The clamping component 1001 may be an upper and lower clamping type, or a left and right clamping type, which are described in details below with reference to FIG. 11 and FIG. 12 respectively.

FIG. 11a and FIG. 11b are a front view and a side view of a clamping component of an upper and lower clamping type in a close and open states respectively.

As shown in FIG. 11a and FIG. 11b, the clamping components 1001 comprises a first clamping component 1101 and a second clamping component 1102 provided on the upper and lower sides of the head-mounted base unit 101 respectively. The first clamping component 1101 and the second clamping 1102 are fixed on the head-mounted base unit 101 respectively by spring hinges 1103 and 1103′, so that the first clamping component 1101 and the second clamping component 1102 can respectively rotate upwards and downwards within a certain range of angle, for example at least 0 to 90 degrees, to hold and fix resiliently a detachable external display unit 107 (such as mobile phone with different display screen widths) or release it. As shown in FIG. 11a, in the initial position (for example, 0 degree), the first clamping component 1101 arranged in the upper part and the second clamping component 1102 arranged in the lower part rotate to the initial position so as to cover the front of the head-mounted base unit 101 to facilitate the user carry the device conveniently. As shown in FIG. 11b, in the clamping position, the first clamping component 1101 arranged in the upper part and the second clamping component 1102 arranged in the lower part open a predetermined angle (for example, 90 degree) to hold the display unit 107 therebetween.

A fixing slot 1104 is provided on the sides of the first clamping component 1101 and the second clamping component 1102 facing each other and is parallel with the optical magnifying lens 102 in use, so that the position of display unit 107 can be adjusted and fixed.

In an unused state, the first clamping component 1101 and the second clamping component 1102 are in a close state, as shown in FIG. 11a. When in use, as shown in FIG. 11b, the user turns the first clamping component 1101 upwards and the second clamping component 1102 downwards, so that the first clamping component 1101 and the second clamping 1102 have a certain vertical space there between. Then the display unit 107 is placed within the provided slot 1104 with the screen side facing the optical magnifying lens 102. When the first clamping component 1101 and the second clamping 1102 are released, the spring hinges press the first clamping component 1101 and the second clamping component 1102 against the display unit 107 tightly due to the resilient pressure. At this point, the game player can adjust the position of the screen of the display unit 107 on the slot 1104 to make the optical magnifying lens 102 face exactly the display screen and thus the images on the screen can be observed through the optical magnifying lens 102.

Preferably, one and more slots 1104 are provided on the sides of the first clamping component 1101 and the second clamping component 1102 facing each other to clamp the display unit 107 at different positions and thus to adjust the distance between the display screen and the human eyes according to the needs of different game players.

Preferably, within the scope of the resilient pressure of the spring hinge, the first clamping component 1101 and the second clamping component 1102 can rotate over 90 degrees for the display units with a bigger size.

The spring hinges in the present invention may adopt the spring hinges used for common glasses.

FIG. 12a and FIG. 12b are the front view and top view of the close and open states of the left and right clamping type clamping components respectively.

The basic structure of the left and right clamping type clamping components is similar as the upper and lower clamping type clamping components 1001, except that the first clamping component 1201 and the second clamping component 1202 are provided on the left and right sides of the head-mounted base unit 101 respectively as shown in FIG. 12a and FIG. 12b to clamp the display unit 107 from the left and right sides. The first clamping component 1201 and the second clamping component 1202 are fixed on the head-mounted base unit 101 respectively by spring hinges 1203 and 1203′ to rotate leftwards and rightwards respectively within a certain range of angle, for example, at least 0-90 degrees and thus hold and fix an external display unit 107 resiliently.

As shown in FIG. 12a, in an unused state, namely the initial position (for example, 0 degree), the first clamping component 1201 and the second clamping component 1202 are in a close state. The first clamping component 1201 in the left part and the second clamping component 1102 in the right part rotate so as to cover the front of the head-mounted base unit 101 to facilitate the user carry the device conveniently.

When in use, as shown in FIG. 12b, the user turns the first clamping component 1201 rightwards and turns the second clamping component 1202 leftwards, so that the first clamping component 1201 and the second clamping 1202 has a certain transverse space therebetween. Then the display unit 107 can be placed within the provided slot 1204 with the screen side facing the optical magnifying lens 102. When the first clamping component 1201 and the second clamping 1202 are released, the spring hinges 1203 and 1203′ press the first clamping component 1201 and the second clamping component 1202 against the display unit 107 tightly due to the resilient pressure. At this point, the game player can adjust the position of the screen of the display unit 107 on the slot 1204 to make the optical magnifying lens 102 face the display screen and thus the images on the screen can be observed through the optical magnifying lens 102.

Preferably, one and more slots 1204 can be arranged on the side of the first clamping component 1201 and the second clamping component 1202 facing each other to hold the display unit 107 at different positions and thus to adjust the distance between the display screen and the human eyes according to the needs of different game players.

Preferably, within the scope of the resilient pressure of the spring hinge, the first clamping component 1201 and the second clamping component 1202 can rotate over 90 degrees for the display units with a bigger size.

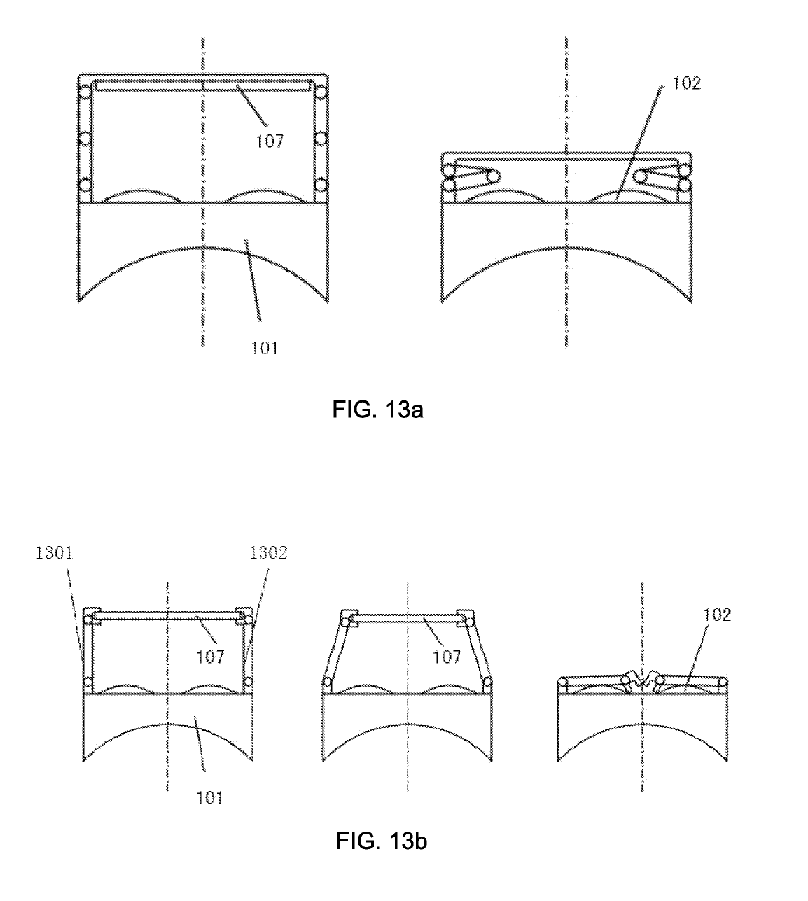

Preferably, the clamping components can be folded through the following several ways as illustrated in FIG. 13a and FIG. 13b.

FIG. 13a illustrates a hinged folding structure of the clamping component with a hinged structure at the midpoint of each clamping component which can be folded to form a smaller volume by folding at the middle articulated position inward.

FIG. 13b illustrates a surround folding structure of the clamping components, in which the rotating arms 1301 and 1302 are connected with the head-mounted base unit 101 by the spring hinges so that on one hand they can hold the display unit 107 of different sizes tightly, and on the other hand they can be rotated to cover the head-mounted base unit 101 after the display unit 107 is removed so that the clamping components can be folded into a smaller volume.

Usually, the display unit is rectangle. The long side is defined as the longitudinal direction, and the short side is defined as the transverse direction. In use, generally the long side is arranged horizontally, and the short side is arranged vertically, so as to adapt the width of the left and the right eye of the user. If it is situation that the position of the game images is not in the middle of the vertical position of the display unit, for example, the screen is on one side along the vertical direction, the upper and lower clamping type clamping components in the first embodiment is more suitable for adjusting the position of the displayed images by moving the display unit to the left or right along the slot. As for the situation that the position of the game images as showed is exactly in the middle of the vertical position of the display unit, either the upper and lower clamping type clamping components or the left and right clamping type clamping components can be used.

The spring hinges may adopt the spring hinge as those used in common glasses.

The beneficial effects of the head-mounted stereoscopic display according to the present invention are listed as below.

1. Stereoscopic images of left and right half width (i.e., half side by side, HSBS in short) can be displayed by a single display unit, so the cost is reduced and the structure is simple for promoting in the market. The stereoscopic images of HSBS which is common in the market can be compressed close to normal proportion to be observed by human eyes, thus it has the advantages of good compatibility. By adjusting the distance between the image height-compressing lens and the display unit, the compression ratio of the picture can be adjusted to match the proportion of different images better.

2. Additional observation windows are provided for the user to look downwards from the inside of the head-mounted base unit, so that it is convenient that the users can use the mouse or keyboard, or observe the obstacles from the opened observation windows without taking off the head-mounted stereoscopic display. Moreover, it is simple to open and close the observation window by a light-blocking cover, which has a simple structure and easy to be fabricated with any one of rotating snap-fit engagement, rotating magnetic engagement and sliding-slot engagement.

3. The product cost can be reduced by using an external display unit in place of a specific display unit integrated with the head-mounted stereoscopic display. Moreover, the first clamping component and the second clamping component can be folded by the spring hinges so that it is easy for storage when the device is not in use and for the user to carry on. The display unit can be suitable with different sizes mobile phones which can be clamped tightly by variable resilient pressure, as needed by the game players. One and more slot are arranged on the side facing each other of the first clamping component and the second clamping component, so as to adjust the distance between eyes and the display unit. There are two different kinds of structures of the clamping components: upper and lower clamping type clamping components and the left and right clamping type clamping components, which is suitable for different applications.

4. The face-mask unit and the optical base unit of the head-mounted base unit 101 can be detached or attached in a variety of way, so the user when wearing the head-mounted base unit 101 can see the outside world clearly after the optical base unit is detached.

5. The head-mounted base unit 101 has enough internal space, which can accommodate user's glasses without taking off their glasses.

6. The bone conduction sound system is adopted, which ensures the user to hear the sound outside while using this product.

7. The structure for adjusting the pupillary distance (PD) is also provided, which can be applied to different pupillary distance.

The selection schemes of the implemental embodiments of the invention are described above, however, and it still can make other variants or modification on the basis of not breaking from design thoughts and ideas of the present invention for those skilled in the art, ought to say, these variants or modification belong to the scope of the protection of the present invention.

Combined with the disclosed description and practice of the present invention, it is easy for those skilled in the art to contemplate and understand other embodiments of the invention. The description and embodiments are merely exemplary, and the scope and spirit of the invention will be limited by the claims.

What is claimed is:

1. A head-mounted stereoscopic display, comprising:
a head-mounted base unit;
a single display unit arranged on the side facing away from human face inside the head-mounted base unit for presenting images to human eyes;
an optical magnifying lens arranged on the side near human face inside the head-mounted base unit; and
an annular headband connected with the head-mounted base unit and extending around user's head for fixing the head-mounted base unit;
wherein the head-mounted base unit comprises a face-mask unit and an optical base unit, the face-mask unit fits with the human face tightly, and the optical base unit fixes the display unit and the optical magnifying lens, and
wherein the single display unit displays two different images for human's left and right eyes respectively side by side simultaneously.

2. The head-mounted stereoscopic display as claimed in claim 1, further comprising an image height-compressing lens, arranged on the side near the display unit inside the head-mounted base unit, for compressing the height of the images as displayed to make the images as observed by eyes have a normal aspect ratio.

3. The head-mounted stereoscopic display as claimed in claim 2, wherein the image height-compressing lens is a plane-concave cylindrical lens or double-concave cylindrical lens.

4. The head-mounted stereoscopic display as claimed in claim 3, wherein the concave surface is arc-shape whose curvature radius is ⅓˜⅕ or ⅔˜⅓ of the height of the display unit.

5. The head-mounted stereoscopic display as claimed in claim 3, wherein the concave surface is a parabolic surface whose curvature radius on the top in cross section is ⅓˜⅕ or ⅔˜⅓ of the height of the display unit.

6. The head-mounted stereoscopic display as claimed in claim 3, wherein the distance between the image height-compressing lens and the display unit is ⅓˜⅕ of the height of the display unit.

7. The head-mounted stereoscopic display as claimed in claim 1, wherein the distance between the optical magnifying lens and the display unit is above 40 mm, and the focal length of the optical magnifying lens is less than 70 mm.

8. The head-mounted stereoscopic display as claimed in claim 1, wherein the diameter of the optical magnifying lens is more than 40 mm, and the gap between the human eyes and the optical magnifying lens is more than 20 mm to accommodate eyeglasses.

9. The head-mounted stereoscopic display as claimed in claim 1, wherein the optical magnifying lens comprises two optical magnifying lenses which are capable of rotating a certain angle from the vertical state, so that the center distance between the two optical magnifying lens will vary within a range of 60 to 70 mm.

10. The head-mounted stereoscopic display as claimed in claim 1, wherein the face-mask unit and the optical base unit are detachable by any of a structure of rotating snap-fit engagement, rotating magnetic engagement and top sliding-slot engagement.

11. The head-mounted stereoscopic display as claimed in claim 1, wherein the annular headband of the head-mounted base unit goes around above ears of the user, and a bone conduction sound module is provided on the annular headband to receive audio signal from outside and vibrate to spread the audio signal.

12. The head-mounted stereoscopic display as claimed in claim 1,
wherein the face-mask unit of the head-mounted base unit concaves a predetermined depth facing away from the human face side, the concave part is surrounded by a forehead-supporting part supporting on the top of the head, a cheek-supporting part supporting on the lower of the head, a nose-supporting part supporting in the middle of the face, and the annular headband supporting the left and right side of the head, so that the head-mounted base unit is held tightly with the human face; and
a pair of observation windows is further provided in the cheek-supporting part of the head-mounted base unit in the lower part of the head, corresponding to the positions through which the user looks downwards with his left and the right eyes, and the observation windows are covered with a slideable light-blocking cover for the user to block the light as needed.

13. The head-mounted stereoscopic display as claimed in claim 12,
wherein the concave part near the observation window further concaves from the vertical direction toward the inside of the head-mounted base unit and forms a wedge triangle “∠” shape together with the cheek-supporting part, in order to provide more observation space below for human eyes to observe through the observation window.

14. The head-mounted stereoscopic display as claimed in claim 12, wherein a sliding slot is provided in the cheek-supporting part, when the light-blocking cover is pushed forward along the sliding slot away from the human face to the end of the slot, the light-blocking cover is opened to reveal the window, and when the light-blocking cover is pushed forward along the sliding slot towards the human face, the light-blocking cover is closed to block the window.

15. The head-mounted stereoscopic display as claimed in claim 12, wherein one end of the light-blocking cover far away from the user is provided with a rotation shaft, while the other end is in a free state,
when the free end of the light-blocking cover is pushed downwards, the light-blocking cover is rotated downwards about 180 degrees and then attached with the cheek-supporting part again, the light-blocking covers is open, and when the free end of the light-blocking cover is rotated in an opposite direction, the light-blocking covers is closed.

16. The head-mounted stereoscopic display as claimed in claim 12, wherein the light-blocking cover is in a louver type.

17. The head-mounted stereoscopic display as claimed in claim 12, wherein the light-blocking cover is provided with a metal or magnetic component which can be engaged with a corresponding metal or magnetic component at the bottom of the head-mounted base unit, so as to be detachable from the head-mounted base unit.

18. The head-mounted stereoscopic display as claimed in claim 1, further comprising clamping components for clamping the display unit in front of the optical magnifying lens away from the human eyes,
wherein the clamping components comprise a first clamping component and a second clamping component arranged in opposite sides to fix an detachable external display unit in place of the display unit in front of the user in position where the user can see the images provided by the external display unit when wearing the head-mounted stereoscopic display.

19. The head-mounted stereoscopic display as claimed in claim 18, wherein the clamping components are rotatable oppositely or reversely within a certain range of angles by spring hinges so as to cover and fold in the front of the optical magnifying lens of the head-mounted base unit in the initial position and to clamp resiliently and fix the external display unit in the operation position.

20. The head-mounted stereoscopic display as claimed in claim 18, wherein the clamping components are provided with one or more slots arranged respectively on the sides facing each other to adjust the distance between the display screen and the human eyes.
